(19) United States
(12) Patent Application Publication
(10) Pub. No.: US 2021/0156710 A1
(43) Pub. Date: May 27, 2021

(54) MAP PROCESSING METHOD, DEVICE, AND COMPUTER-READABLE STORAGE MEDIUM

(71) Applicant: SZ DJI TECHNOLOGY CO., LTD., Shenzhen (CN)

(72) Inventors: Bo WU, Shenzhen (CN); Ang LIU, Shenzhen (CN); Litian ZHANG, Shenzhen (CN)

(21) Appl. No.: 17/162,977

(22) Filed: Jan. 29, 2021

Related U.S. Application Data
(63) Continuation of application No. PCT/CN2018/098039, filed on Aug. 1, 2018.

(51) Int. Cl. G01C 21/00

(52) U.S. Cl. CPC G01C 21/3807; G01C 21/3867

(57) ABSTRACT

A map processing method includes determining, in a map coordinate system, a first coordinate position corresponding to a position of a movable device, determining, in the map coordinate system, a second coordinate position corresponding to pixel feature information of a map data source, and determining an accessible state of a target coordinate position in a map according to the first coordinate position and the second coordinate position. The accessible state of the target coordinate position indicating that the target coordinate position is not occupied by obstacles.

### CROSS-REFERENCE TO RELATED APPLICATION

This application is a continuation of International Application No. PCT/CN2018/098039, filed Aug. 1, 2018, the entire content of which is incorporated herein by reference.

### TECHNICAL FIELD

The present disclosure relates to the field of map technology and, in particular, to a map processing method, a device, and a computer-readable storage medium.

### BACKGROUND

Maps are an indispensable part of movable devices to achieve navigation. Movable devices, for example, unmanned aerial vehicles (UAVs), unmanned vehicles, robots, etc., can use maps to realize path planning, and then move according to the planned path. For example, when a UAV flies, there are obstacles in the environment, especially in an indoor flying environment, there are various obstacles such as walls or devices, so it is needed to form a map describing the environment and make a path planning to avoid obstacles during the flight.

In related map processing methods, after obstacle information is determined in a map data source, according to the obstacle information, only an inaccessible state of a corresponding position in the map indicating that the position is occupied by the obstacle is determined. Using the map obtained by the above manner, for an environment outside a field of view, only a location of a detected obstacle can be determined, and it is impossible to know whether other locations are obstacle-free or undetected, therefore the movable device is restricted to perform a path planning only within the field of view, and a path planning area is limited.

### SUMMARY

In accordance with the disclosure, there is provided a map processing method including determining, in a map coordinate system, a first coordinate position corresponding to a position of a movable device, determining, in the map coordinate system, a second coordinate position corresponding to pixel feature information of a map data source, and determining an accessible state of a target coordinate position in a map according to the first coordinate position and the second coordinate position. The accessible state of the target coordinate position indicating that the target coordinate position is not occupied by obstacles.

Also in accordance with the disclosure, there is provided an electronic device including a memory storing program codes and a processor configured to execute the program codes to determine, in a map coordinate system, a first coordinate position corresponding to a position of a movable device, determine, in the map coordinate system, a second coordinate position corresponding to pixel feature information of a map data source, and determine an accessible state of a target coordinate position in a map according to the first coordinate position and the second coordinate position. The accessible state of the target coordinate position indicating that the coordinate position is not occupied by obstacles.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts.

FIG. 1 is a schematic flowchart of a map processing method according to an embodiment of the disclosure.

FIGS. 2 and 3 are schematic diagrams showing maps during map processing according to an embodiment of the disclosure.

FIG. 4 is a structural block diagram of an electronic device according to an embodiment of the disclosure.

### DETAILED DESCRIPTION OF THE EMBODIMENTS

The technical solutions in the example embodiments of the present disclosure will be described clearly with reference to the accompanying drawings. The described embodiments are only some of the embodiments of the present disclosure, rather than all the embodiments. Based on the embodiments of the present disclosure, all other embodiments obtained by a person of ordinary skill in the art without creative efforts shall fall within the scope of the present disclosure. In the case of no conflict, the following embodiments and the features in the embodiments can be combined with each other.

The terminology used in this disclosure is for the purpose of describing particular embodiments only and is not intended to limit the disclosure. As used in this disclosure and the appended claims, the singular forms “a” and “the” are intended to include the plural forms as well, unless the context clearly indicates otherwise. The term “and/or” as used herein refers to and includes any or all possible combinations of one or more of the associated listed items.

In the present disclosure, relational terms such as “first,” “second,” and “third” are only used to distinguish information of the same type from each other. For example, without deviating from the scope of the present disclosure, first information may also be referred to as second information, and similarly, second information may also be referred to as first information. Depending on the context, the word “if” can be interpreted as “when,” “while,” or “in response to determining.”

The embodiments of the present disclosure provide a map processing method, which can be applied to an electronic device. The electronic device may be a movable device. The electronic device may also be an electronic device other than a movable device, which is not limited. When the electronic device is not a movable device, the electronic device can be mounted at a movable device and electrically or communicatively connected with the movable device, or the electronic device can be wirelessly communicatively connected with the movable device. During the movement of the movable device, a state of a coordinate position in the map is determined and a real-time path planning is performed.

The movable device includes, for example, an unmanned aerial vehicle (UAV), an unmanned vehicle, or a robot, etc. The map obtained by the map processing method of the embodiments of the present disclosure can realize an autonomous navigation function such as a path planning. The movable device can be provided with a collection device to collect map data sources during the flight. The collection device can be one or more of a camera, a vision sensor, or another ranging sensor. Correspondingly, the map data source can be collected by a camera, or can be obtained by fusing data collected by a vision sensor and another ranging sensor, which is not limited.

The map processing method of the embodiments of the present disclosure is described in more detail below, but it should not be limited thereto.

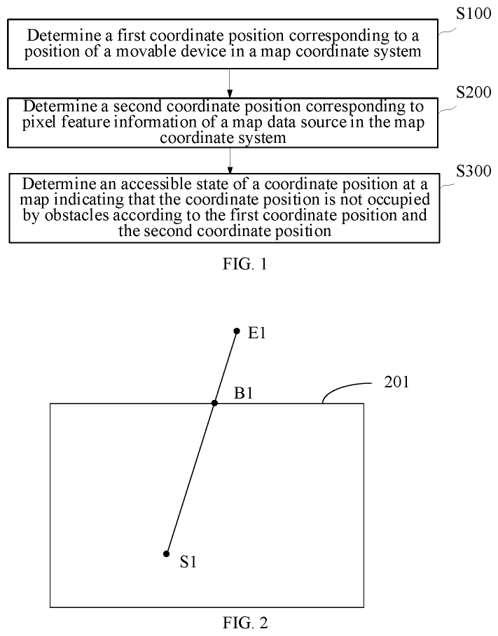

As shown in FIG. 1, the map processing method includes determining a first coordinate position corresponding to a position of a movable device in a map coordinate system (S100), determining a second coordinate position corresponding to pixel feature information of a map data source in the map coordinate system (S200), and, according to the first coordinate position and the second coordinate position, determining an accessible state of a coordinate position in the map indicating that the coordinate position is not occupied by obstacles (S300). A coordinate position in the map for which the state thereof is determined is also referred to as a “target coordinate position.”

In some embodiments, an execution entity of the map processing method may be an electronic device, and further may be a processor of the electronic device. There may be one or more processors, and the processor may be a general-purpose processor or a special-purpose processor. In the embodiments, for example, the electronic device is a movable device, which is not limited.

The movable device may be provided with an imaging device for collecting map data sources, and the map data source is collected through the imaging device. The movable device is, for example, a UAV, and the imaging device may be a camera carried by the UAV. In some embodiments, the movable device may have an imaging function, and the movable device may obtain a map data source by using the imaging function.

The map is used in the map coordinate system and the map coordinate system can be a world coordinate system. The map coordinate system can also be a designated coordinate system. The transformation of the coordinate position between the designated coordinate system and the world coordinate system can be realized according to a correspondence relationship between the world coordinate system and the designated coordinate system.

The map may be a local dynamic map created during the movement of the movable device. During the movement of the movable device, the local dynamic map corresponding to a set area is created, and a state of the coordinate position at the corresponding local dynamic map is determined according to the map data source collected at the location, therefore a real-time navigation can be performed during the flight.

The map can also be a static map corresponding to the set area created before the flight, and the state of the coordinate position at the static map is updated by using the map data source collected in multiple directions in the set area by the movable device to obtain a static map describing an environment of the set area. A path is planned using the static map, and the movable device or another movable device that collects the map data source can move along the planned path.

Before process S100, a map may be created first, and the state of the coordinate position in the map may be initialized to an unknown state. A size of the map can be determined according to needs and is not limited. When a local dynamic map is created, a creation area is determined based on the location of the movable device. A size of the created map is not limited, and the map may have an area update following the movable device. The area update includes deleting map units and creating map units, etc.

As the movable device moves, the coordinate position corresponding to the position of the movable device in the map coordinate system moves accordingly, but remains within the map. At certain moments, the imaging device at the movable device collects map data sources. Each time the map data source is collected, the location of the movable device can be determined, so that each map data source can correspond to the location of the movable device.

At S100, the processor determines the first coordinate position corresponding to the position of the movable device in the map coordinate system.

For each map data source collected, as long as the movable device moves, a corresponding first coordinate position can be obtained. In other words, the map data source corresponds to the first coordinate position, and the correspondence can be one-to-one, or many-to-one, which is not limited.

In some embodiments, in order to improve accuracy, the map data source can be obtained by continuously collecting multiple images and performing statistics on the pixel feature information of the obtained images, so as to avoid determining obstacles as open areas in the map data source.

At S200, the processor determines the second coordinate position corresponding to the pixel feature information of the map data source in the map coordinate system.

The invalid pixel feature information in the map data source can be excluded. The invalid pixel feature information is, for example, an abnormal pixel whose pixel feature is an abnormal value. The abnormal value can be set as needed, which is not limited. Therefore, for a map data source, the number of second coordinate positions corresponds to the number of valid pixel feature information in the map data source.

In some embodiments, determining the second coordinate position corresponding to the pixel feature information of the map data source in the map coordinate system (S200) further includes determining whether the pixel feature information of the map data source meets a specified condition, and if so, determining the second coordinate position corresponding to the pixel feature information in the map coordinate system.

The pixel feature information of the map data source that meets the specified condition is used to determine the second coordinate position. The needed pixel feature information of the map data source can be chosen to determine the state of the coordinate position. The specified condition can be set as needed.

If the pixel feature information meets the specified condition, the information is valid pixel feature information, and the corresponding second coordinate position needs to be determined, otherwise the information is invalid pixel feature information and is skipped directly.

In some embodiments, determining whether the pixel feature information of the map data source meets the specified condition may include determining whether a specified pixel feature of the pixel in the map data source is within a set value range, and if so, determining that the pixel feature information meets the specified condition.

Determining whether the pixel feature information of the map data source is within the set value range can exclude abnormal pixels whose pixel features are preset null values. Other specified conditions can also be set to exclude abnormal pixels. An abnormal pixel may include, for example, a pixel whose pixel feature is a preset null value, and/or a pixel whose pixel feature is an outlier relative to a neighboring pixel. The outlier is, for example, a pixel whose absolute value of a difference between the pixel feature and the neighboring pixel feature exceeds an allowable range.

The second coordinate position corresponding to each piece of pixel feature information can be determined in the map coordinate system in a manner of traversing the pixel feature information of the map data source. In some embodiments, process S300 may be performed each time the second coordinate position corresponding to one piece of pixel feature information is determined in the map coordinate system. In some other embodiments, process S300 may be performed after all the second coordinate positions are determined in the map coordinate system. The pixel feature information that does not meet the specified conditions can be excluded during the traversal process.

At S300, the processor determines an accessible state of a coordinate position in the map indicating that the coordinate position is not occupied by obstacles according to the first coordinate position and the second coordinate position.

The second coordinate position is a coordinate position corresponding to an obstacle in the map coordinate system. Further, an area between the movable device as an observation point and the observed obstacle must be free of obstacles, so according to the second coordinate position and the first coordinate position corresponding to the position of the movable device, the coordinate position in the map with the accessible state indicating that the coordinate position is not occupied by obstacles can be determined, and the corresponding state is marked.

In the related map processing method, because the state of the coordinate position in the map is determined only based on the obstacle information in the map data source, only the state indicating being occupied by the obstacle is marked in the map, and other states are not marked. For example, during a flight of the UAV, the accessible state of not being occupied by the obstacle for the map area within the field of view can be determined, but for the map area outside the field of view, it cannot be determined whether the area between the UAV and the obstacle has been observed and determined to be an accessible area, or has not been observed, so it is impossible to plan a path for the map area outside the field of view. Therefore, when the UAV is only provided with a forward-looking camera, even the left and right areas have been observed before, but since the left and right areas are not currently in the field of view, it cannot be determined whether the area between the UAV and the obstacle is accessible or unobserved, therefore, the UAV cannot make a large-angle left-or-right turn.

In the map processing method of the embodiments of the present disclosure, in the map coordinate system, the second coordinate position corresponding to the pixel feature information of the map data source and the first coordinate position corresponding to the position of the movable device can be determined, and according to the first coordinate position and the second coordinate position, the accessible state of the coordinate position in the map indicating that the coordinate position is not occupied by obstacles can be determined. Therefore, during the movement of the movable device, even if the left and right areas are not in the current field of view, as long as they have been observed before, the map can be used to determine whether the left and right areas are accessible, so that according to the processed map, not only the path planning within the field of view, but also the path planning outside the field of view can be realized.

There are obstacle areas and open areas in the map data source. The pixel feature information in the obstacle area corresponds to the second coordinate position in the map coordinate system, i.e., the position corresponding to the obstacle, which may or may not be in the map, depending on the area where the map is created. The second coordinate position in the map coordinate system corresponding to the pixel feature information in the open area is infinity.

In some embodiments, determining the first coordinate position corresponding to the position of the movable device in the map coordinate system (S100) includes determining the first coordinate position corresponding to the position of the movable device in the map coordinate system according to the position of the movable device measured when the map data source is collected.

The position of the movable device can be determined by using a pose positioning system of the movable device, and a measurement time can be a time when the map data source is collected. The pose positioning system is, for example, an inertial measurement system, or a vision positioning system, etc.

For example, the map coordinate system is a world coordinate system. At the time of collecting the map data source (exposure time of the imaging device), a position of the movable device measured by the pose positioning system is directly used as the first coordinate position in the map coordinate system. If the map coordinate system is not a world coordinate system but a designated coordinate system, the position of the movable device measured by the pose positioning system can be transformed from the world coordinate system to the designated coordinate system.

In some embodiments, determining the second coordinate position corresponding to the pixel feature information of the map data source in the map coordinate system (S200) includes determining an intermediate coordinate position corresponding to the pixel feature information of the map data source in a first coordinate system used by the map data source (S201), and transforming the intermediate coordinate position from the first coordinate system to the second coordinate position in the map coordinate system according to a correspondence relationship between the first coordinate system and the map coordinate system (S202).

At S201, the processor determines the intermediate coordinate position corresponding to the pixel feature information of the map data source in the first coordinate system used by the map data source.

The first coordinate system is a coordinate system established by the imaging device. For example, when the imaging device is a camera, the first coordinate system is a camera coordinate system. Since the camera collects the map data source, the map data source uses the camera coordinate system, and each piece of pixel feature information has a corresponding intermediate coordinate position in the camera coordinate system.

At S202, the processor transforms the intermediate coordinate position from the first coordinate system to the second coordinate position in the map coordinate system according to the correspondence relationship between the first coordinate system and the map coordinate system.

The correspondence relationship between the first coordinate system and the map coordinate system is variable. With the movement of the movable device and/or a relative movement between the imaging device and the movable device, the correspondence relationship changes accordingly. The correspondence relationship between the first coordinate system and the map coordinate system can be determined and established in advance before the map processing.

With a known correspondence relationship between the first coordinate system and the map coordinate system, the intermediate coordinate position can be transformed from the first coordinate system to the second coordinate position in the map coordinate system, that is, the second coordinate position corresponding to the pixel feature information of the map data source in the map coordinate system is determined.

In some embodiments, the pixel feature information includes a specified pixel feature of the pixel and a source coordinate position of the pixel in a second coordinate system. The second coordinate system and the first coordinate system are different coordinate systems used by the map data source. The second coordinate system is, for example, an image coordinate system, and a transformation relationship from the second coordinate system to the first coordinate system is a back projection relationship from a two-dimensional image space to a three-dimensional image space.

In some embodiments, determining the intermediate coordinate position corresponding to the pixel feature information of the map data source in the first coordinate system (S201) includes determining a first coordinate-axis value of the intermediate coordinate position in the first coordinate system according to the specified pixel feature of the pixel of the map data source (S2011), and determining a second coordinate-axis value and a third coordinate-axis value of the intermediate coordinate position in the first coordinate system according to the source coordinate position of the pixel of the map data source in the second coordinate system and the first coordinate-axis value (S2012).

In some embodiments, the map data source is a parallax map and the specified pixel feature is a parallax value, and determining the first coordinate-axis value of the intermediate coordinate position in the first coordinate system according to the specified pixel feature of the pixel of the map data source (S2011) includes converting the parallax value of the pixel in the map data source into a depth value, and determining the depth value as the first coordinate-axis value of the intermediate coordinate position in the first coordinate system.

In some embodiments, the map data source is a depth map and the specified pixel feature is a depth value, and determining the first coordinate-axis value of the intermediate coordinate position in the first coordinate system according to the specified pixel feature of the pixel of the map data source (S2011) includes determining the depth value of the pixel in the map data source as the first coordinate-axis value of the intermediate coordinate position in the first coordinate system.

The parallax value can reflect a distance between an object in a scene and the imaging device. The closer the distance, the greater the parallax value. The depth value can also reflect the distance between the object in the scene and the imaging device. The closer the distance, the smaller the depth value.

The parallax value and the depth value can be mutually converted, therefore no matter whether the map data source is a parallax map or a depth map, the first coordinate-axis value of the intermediate coordinate position in the first coordinate system can be determined according to the specified pixel feature of the pixel of the map data source.

In some embodiments, when the specified pixel feature is a parallax value, the processes of determining the intermediate coordinate position corresponding to the pixel feature information of the map data source in the first coordinate system used by the map data source, that is, processes S2011 and S2012, can be implemented through the following formulas (1)-(3).

Z_cam=f*b/d (1)

X_cam=(u−u0)*Z_cam/f (2)

Y_cam=(v−v0)*Z_cam/f (3)

where, the intermediate coordinate position P_cam=(X_cam, Y_cam, Z_cam), Z_cam is the first coordinate-axis value, X_cam is the second coordinate-axis value, Y_cam is the third coordinate-axis value, (u0, v0) is a reference coordinate position in the second coordinate system (for example, a coordinate position of a center point of the map data source), (u, v) is the source coordinate position of the pixel of the map data source in the second coordinate system, f is a focal length, d is the parallax value, b is a baseline length between the binocular lenses of the imaging device.

In some embodiments, transforming the intermediate coordinate position from the first coordinate system to the second coordinate position in the map coordinate system according to the correspondence relationship between the first coordinate system and the map coordinate system (S202) includes transforming the intermediate coordinate position from the first coordinate system to a device coordinate system according to a correspondence relationship between the first coordinate system and the device coordinate system (S2021), and transforming the intermediate coordinate position that has been transformed into the device coordinate system from the device coordinate system to the second coordinate position in the map coordinate system according to a correspondence relationship between the device coordinate system and the map coordinate system (S2022).

After the intermediate coordinate position is determined in the first coordinate system, the intermediate coordinate position can be transformed from the first coordinate system to the device coordinate system. Then, the intermediate coordinate position that has been transformed into the device coordinate system is transformed from the device coordinate system to the map coordinate system to obtain the second coordinate position in the map coordinate system.

The device coordinate system can be, for example, a coordinate system used by the movable device. Since the movable device usually has a pose positioning system for pose determination, the device coordinate system can be used as a medium of the correspondence relationship between the first coordinate system and the map coordinate system, therefor it can be easier to determine the correspondence relationship. Further, the pose positioning system of the movable device has a better accuracy, and the measured pose of the movable device can improve an accuracy of the transformed second coordinate position.

The first coordinate system and the device coordinate system can also be a same coordinate system, therefore process S2021 can be omitted, and directly according to the correspondence relationship between the first coordinate system and the map coordinate system, the intermediate coordinate position that has been transformed into the device coordinate system is transformed from the device coordinate system to the second coordinate position in the map coordinate system.

In some embodiments, the map data source is collected by an imaging device mounted at the movable device.

The first coordinate system is established based on the imaging device, for example, based on a certain point at the imaging device. The device coordinate system is established based on the movable device, for example, based on a certain point at the movable device. The correspondence relationship between the first coordinate system and the device coordinate system includes a relative attitude and a relative position between the imaging device and the movable device.

When the imaging device and the movable device are relatively fixed, or when the movable device has an imaging function and serves as an imaging device at the same time, the first coordinate system can be shared, and there is no need to perform transformation between the first coordinate system and the device coordinate system.

Since the first coordinate system is established based on the imaging device, the first coordinate system moves with the imaging device. Similarly, the device coordinate system is established based on the movable device, so the device coordinate system moves with the movable device. Therefore, the correspondence relationship between the first coordinate system and the device coordinate system can be determined by a relative pose between the imaging device and the movable device. The relative pose includes a relative position and a relative attitude.

At S2021, the coordinate position needs to be transformed from the first coordinate system to the device coordinate system, so the correspondence relationship is a pose relationship of the movable device relative to the imaging device. The correspondence relationship can also be a pose relationship of the imaging device relative to the movable device, as long as a mutual transformation relationship can be determined.

The imaging device can be fixed at the movable device, so that the relative pose between the imaging device and the movable device is fixed, or the imaging device can be rotatably mounted at the movable device, so that the relative pose between the imaging device and the movable device is variable.

In some embodiments, the relative attitude and relative position between the imaging device and the movable device are specified parameters. If the relative pose between the imaging device and the movable device is fixed, the relative attitude and relative position can be used once they are determined. For example, when the imaging device is fixedly mounted at the movable device, the relative pose between the imaging device and the movable device is fixed after a calibration, that is, a calibrated relative pose is used as the specified parameter.

In some embodiments, the relative attitude and relative position between the imaging device and the movable device may be measured parameters measured when the map data source is collected. For example, when the imaging device is rotatably mounted at the movable device, the imaging device can rotate relative to the movable device, so the relative attitude and relative position are variable. In this scenario, the pose of the imaging device can be determined by images collected by the imaging device, and the pose of the movable device can be determined by the pose positioning system of the movable device, so as to determine the relative pose between the imaging device and the movable device according to the determined pose of the imaging device and the pose of the movable device. When the imaging device is fixedly mounted at the movable device, the relative attitude and relative position can also be measured parameters measured when the map data source is collected, which can prevent errors from pose changes between the imaging device and the movable device.

In some embodiments, the correspondence relationship between the device coordinate system and the map coordinate system includes the first coordinate position and attitude data corresponding to the movable device in the map coordinate system. The attitude data can be represented by Euler angles, for example.

In some embodiments, the first coordinate position and the attitude data are determined according to the pose data of the movable device measured when the map data source is collected.

For example, the map coordinate system is a world coordinate system. At the time of collecting the map data source (exposure time of the imaging device), the position and attitude of the movable device measured by the pose positioning system can be directly used as the first coordinate position in the map coordinate system and the attitude data corresponding to the movable device. If the map coordinate system is not a world coordinate system but a designated coordinate system, the pose of the movable device measured by the pose positioning system can be transformed from the world coordinate system to the designated coordinate system.

In some embodiments, according to the correspondence relationship between the first coordinate system and the map coordinate system, transforming the intermediate coordinate position from the first coordinate system to the second coordinate position in the map coordinate system, that is, processes S2021 and S2022, can be implemented by the following formulas (4) and (5).

P_body=Rcam2body*P_cam+Tcam2body (4)

pt_end=Rbody2world*P_body+pt_start (5)

where Rcam2body is the relative attitude between the imaging device and the movable device, Tcam2body is the relative position between the imaging device and the movable device, P_cam is the intermediate coordinate position in the first coordinate system, P_body is the intermediate coordinate position transformed to the device coordinate system, Pt_start is the first coordinate position, Rbody2world is the attitude data corresponding to the movable device in the map coordinate system, and pt_end is the second coordinate position.

In some embodiments, determining an accessible state of a target coordinate position in the map indicating that the target coordinate position is not occupied by obstacles according to the first coordinate position and the second coordinate position (S300) includes, when the second coordinate position is not in the map and if a coordinate position between the first coordinate position and the second coordinate position is in the map, changing a state of the coordinate position from a marked unknown state to the accessible state indicating not being occupied by obstacles.

In related map processing methods, a scenario where the second coordinate position is not in the map is generally ignored, that is, the second coordinate position that is not in the map is directly discarded, and only a scenario where the second coordinate position is in the map is considered.

In the embodiments of the present disclosure, when the second coordinate position is not in the map, it means that a position corresponding to the obstacle is not in the map (for example, at infinity), and whether the coordinate position between the first coordinate position and the second coordinate position is in the map needs to be determined. If the coordinate position is in the map, the state of the coordinate position is an accessible state indicating not being occupied by obstacles, and the unknown state obtained by initialization is updated to the accessible state.

Since the second coordinate position is no longer limited to a position corresponding to an obstacle in the map, it also includes a position corresponding to an obstacle outside the map (including a position at infinity), and when the second coordinate position is outside the map, it indicates an area between the observation point and the obstacles is at an accessible state indicating not being occupied by the obstacles, therefore the state of the coordinate position in the map between the first coordinate position and the second coordinate position is modified to the accessible state.

The manner of determining whether the coordinate position between the first coordinate position and the second coordinate position is in the map is, for example, determining a straight line passing through the first coordinate position and the second coordinate position, determining a map boundary position on the straight line, and determining coordinate positions between the first coordinate position and the map boundary position on the straight line as the coordinate positions in the map.

As shown in FIG. 2, S1 is the first coordinate position in the map coordinate system, which is in a map 201. E1 is the second coordinate position in the map coordinate system, which is not in the map 201. B1 is an intersection point of a line between S1 and E1 and a map boundary, that is the map boundary position. The coordinate positions between S1 and B1 are the coordinate positions in the map between the first coordinate position and the second coordinate position, and the state of these coordinate positions is changed from unknown to the accessible state.

In some embodiments, determining the accessible state of the coordinate position in the map indicating that the coordinate position is not occupied by obstacles according to the first coordinate position and the second coordinate position (S300) includes, when the second coordinate position is in the map, changing the state of the coordinate position between the first coordinate position and the second coordinate position from a marked unknown state to an accessible state indicating that the coordinate position is not occupied by obstacles.

When the second coordinate position is in the map, it means that the position corresponding to the obstacle is in the map, then the coordinate positions between the first coordinate position and the second coordinate position must be in the map, the state of these coordinate positions is the accessible state of not being occupied by obstacles, and the unknown state of these coordinate positions is directly updated to the accessible state.

The manner of determining the coordinate positions between the first coordinate position and the second coordinate position is, for example, determining a straight line passing through the first coordinate position and the second coordinate position, and determining the coordinate positions between the first coordinate position and the second coordinate position. The state of these coordinate positions is changed from the unknown state to the accessible state.

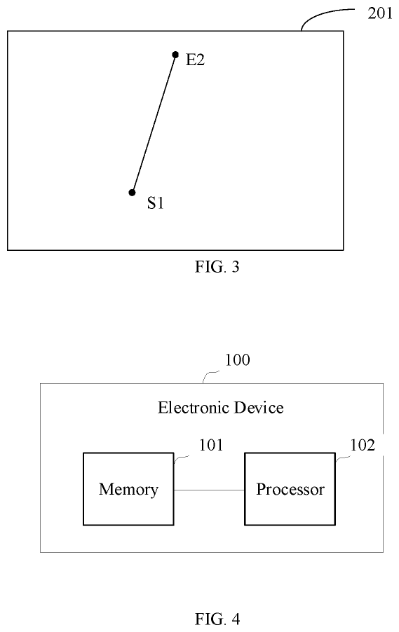

As shown in FIG. 3, S1 is the first coordinate position in the map coordinate system, which is in the map 201. E2 is the second coordinate position in the map coordinate system, which is in the map 201. The state of the coordinate positions between S1 and E2 is changed from the unknown state to the accessible state.

In some embodiments, after process S200, the map processing method further includes determining an inaccessible state of the coordinate position in the map indicating that the coordinate position is occupied by obstacles according to the second coordinate position.

In some embodiments, determining the inaccessible state of the coordinate position in the map indicating that the coordinate position is occupied by obstacles according to the second coordinate position includes, when the second coordinate position is in the map, changing the state of the second coordinate position from the marked unknown state to the inaccessible state indicating that the second coordinate position is occupied by obstacles.

When the second coordinate position is in the map, it means that the position corresponding to the obstacle is in the map, and the state of the second coordinate position is updated from the marked unknown state to the inaccessible state. In this way, the states in the map include an accessible state, an in accessible state, and an unknown state.

As shown in FIG. 3, E2 is the second coordinate position in the map coordinate system, which is in the map 201, and the state of E2 is changed from the unknown state to the inaccessible state.

In some embodiments, the coordinate positions between the first coordinate position and the second coordinate position are collinear with the first coordinate position and the second coordinate position. The coordinate positions between the first coordinate position and the second coordinate position do not include the first coordinate position and the second coordinate position.

Because of the different representations of the map, each map unit in the map presents a different form. For example, if the map is a grid map, each unit in the map is a grid.

It can be determined whether the grid is under an accessible state according to whether the coordinate position on the line connecting the first coordinate position and the second coordinate position is at the grid, or it can be determined whether the grid is under an inaccessible state according to whether the second coordinate position is at the grid. When a grid has a conflict between an inaccessible state and an accessible state, the state of the grid can be determined as an inaccessible state.

A position at the grid can be specified as the coordinate position for determining the state mark (for example, a center point of the grid). A coordinate position between the first coordinate position and the second coordinate position can be the coordinate position for determining the state mark, as long as the coordinate position is at the grid where the line connecting the first coordinate position and the second coordinate position passes (it can be determined whether the coordinate position is at the grid where the line passes according to a distance between the coordinate position for determining the state mark and the line). The coordinate position between the first coordinate position and the second coordinate position may not be collinear with the first coordinate position and the second coordinate position.

Referring to FIG. 4, the present disclosure also provides an electronic device 100, which includes a memory 101 and a processor 102 (such as one or more processors).

The memory 101 is configured to store program codes. The processor 102 is configured to call the program codes, and when the program codes are executed, the processor 102 is configured to determine a first coordinate position corresponding to a position of a movable device in a map coordinate system, determine a second coordinate position corresponding to pixel feature information of a map data source in the map coordinate system, and determine an accessible state of a coordinate position in a map indicating that the coordinate position is not occupied by obstacles according to the first coordinate position and the second coordinate position.

In some embodiments, when determining the accessible state of the coordinate position in the map indicating that the coordinate position is not occupied by obstacles according to the first coordinate position and the second coordinate position, the processor is configured to, when the second coordinate position is not in the map and if a coordinate position between the first coordinate position and the second coordinate position is in the map, change a state of the coordinate position from a marked unknown state to the accessible state indicating not being occupied by obstacles.

In some embodiments, determining the accessible state of the coordinate position in the map indicating that the coordinate position is not occupied by obstacles according to the first coordinate position and the second coordinate position, the processor is configured to, when the second coordinate position is in the map, change the state of the coordinate position between the first coordinate position and the second coordinate position from a marked unknown state to an accessible state indicating that the coordinate position is not occupied by obstacles.

In some embodiments, the coordinate position between the first coordinate position and the second coordinate position is collinear with the first coordinate position and the second coordinate position.

In some embodiments, after determining the second coordinate position corresponding to the pixel feature information of the map data source in the map coordinate system, the processor is further configured to determine an inaccessible state of the coordinate position in the map indicating that the coordinate position is occupied by obstacles according to the second coordinate position.

In some embodiments, when determining an inaccessible state of the coordinate position in the map indicating that the coordinate position is occupied by obstacles according to the second coordinate position, the processor is configured to, when the second coordinate position is in the map, change the state of the second coordinate position from the marked unknown state to the inaccessible state indicating that the coordinate position is occupied by obstacles according to the second coordinate position.

In some embodiments, when determining the second coordinate position corresponding to the pixel feature information of the map data source in the map coordinate system, the processor is configured to determine an intermediate coordinate position corresponding to the pixel feature information of the map data source in a first coordinate system used by the map data source, and transform the intermediate coordinate position from the first coordinate system to a second coordinate position in the map coordinate system according to a correspondence relationship between the first coordinate system and the map coordinate system.

In some embodiments, the pixel feature information includes a specified pixel feature of the pixel and a source coordinate position of the pixel in a second coordinate system. The second coordinate system and the first coordinate system are different coordinate systems used by the map data source.

When determining the intermediate coordinate position corresponding to the pixel feature information of the map data source in the first coordinate system, the processor is configured to determine a first coordinate-axis value of the intermediate coordinate position in the first coordinate system according to the specified pixel feature of the pixel of the map data source, and determine a second coordinate-axis value and a third coordinate-axis value of the intermediate coordinate position in the first coordinate system according to the source coordinate position of the pixel of the map data source in the second coordinate system and the first coordinate-axis value.

In some embodiments, the map data source is a parallax map, and the specified pixel feature is a parallax value.

When determining the first coordinate-axis value of the intermediate coordinate position in the first coordinate system according to the specified pixel feature of the pixel of the map data source, the processor is configured to convert the parallax value of the pixel in the map data source into a depth value, and determine the depth value as the first coordinate-axis value of the intermediate coordinate position in the first coordinate system.

In some embodiments, the map data source is a depth map, and the specified pixel feature is a depth value.

When determining the first coordinate-axis value of the intermediate coordinate position in the first coordinate system according to the specified pixel feature of the pixel of the map data source, the processor is configured to determine the depth value of the pixel in the map data source as the first coordinate-axis value of the intermediate coordinate position in the first coordinate system.

In some embodiments, when transforming the intermediate coordinate position from the first coordinate system to the second coordinate position in the map coordinate system according to a correspondence relationship between the first coordinate system and the map coordinate system, the processor is configured to transform the intermediate coordinate position from the first coordinate system to a device coordinate system according to a correspondence relationship between the first coordinate system and the device coordinate system, and transform the intermediate coordinate position that has been transformed into the device coordinate system from the device coordinate system to the second coordinate position in the map coordinate system according to a correspondence relationship between the device coordinate system and the map coordinate system.

In some embodiments, the map data source is collected by an imaging device mounted at the movable device.

The first coordinate system is established based on the imaging device, and the device coordinate system is established based on the movable device.

The correspondence relationship between the first coordinate system and the device coordinate system includes a relative attitude and a relative position between the imaging device and the movable device.

In some embodiments, the relative attitude and relative position are specified parameters, or the relative attitude and relative position are measured parameters measured when the map data source is collected.

In some embodiments, the correspondence relationship between the device coordinate system and the map coordinate system includes the first coordinate position and attitude data corresponding to the movable device in the map coordinate system.

In some embodiments, the first coordinate position and the attitude data are determined according to the pose data of the movable device measured when the map data source is collected.

In some embodiments, when determining the second coordinate position corresponding to the pixel feature information of the map data source in the map coordinate system, the processor is further configured to determine whether the pixel feature information of the map data source meets a specified condition, and if so, determine the second coordinate position corresponding to the pixel feature information in the map coordinate system.

In some embodiments, when determining whether the pixel feature information of the map data source meets the specified condition, the processor is configured to determine whether a specified pixel feature of the pixel in the map data source is within a set value range, and if so, determine that the pixel feature information meets the specified condition.

In some embodiments, when determining the first coordinate position corresponding to the position of the movable device in the map coordinate system, the processor is configured to determine the first coordinate position corresponding to the position of the movable device in the map coordinate system according to the position of the movable device measured when the map data source is collected.

A computer-readable storage medium is provided according to an embodiment of the present disclosure. The computer-readable storage medium stores computer instructions. When the computer instructions are executed, the map processing method described above is implemented.

The systems, devices, modules or units explained in the above embodiments may be realized by computer chips or entities, or realized by products with certain functions. A typical implementation device is a computer. The specific form of the computer can be a personal computer, a laptop computer, a cellular phone, a camera phone, a smart phone, a personal digital assistant, a media player, a navigation device, an email receiving and sending device, and a game control console, a tablet computer, a wearable device, or a combination of any of these devices.

For the convenience of description, when the above device is described, the functions are divided into various units and described separately. When the present disclosure is implemented, the functions of each unit can be implemented in the same one or more software and/or hardware.

Those skilled in the art should understand that the embodiments of the present disclosure may be provided as methods, systems, or computer program products. Therefore, the present disclosure may adopt a form of a complete hardware embodiment, a complete software embodiment, or an embodiment combining software and hardware. Moreover, the embodiments of the present disclosure may adopt a form of computer program products implemented at one or more computer-readable storage media (including but not limited to a disk storage, a CD-ROM, an optical storage, etc.) containing computer-usable program codes.

The present disclosure is described with reference to flowcharts and/or block diagrams of methods, devices (systems), and computer program products according to the embodiments of the present disclosure. It should be understood that each process and/or block in the flowchart and/or block diagram, and the combination of processes and/or blocks in the flowchart and/or block diagram can be realized by computer program instructions. These computer program instructions can be provided to a processor of a general-purpose computer, a special-purpose computer, an embedded processor, or another programmable data processing device to generate a machine, so that the instructions executed by the processor of the computer or other programmable data processing device generates a device that realizes the functions specified in one process or multiple processes in the flowchart and/or one block or multiple blocks in the block diagram.

Moreover, these computer program instructions can also be stored in a computer-readable memory that can guide a computer or another programmable data processing device to work in a specific manner, so that the instructions stored in the computer-readable memory produce a product including the instruction device. The instruction device implements functions specified in one process or multiple processes in the flowchart and/or one block or multiple blocks in the block diagram.

These computer program instructions can also be loaded into a computer or another programmable data processing device, so that a series of operation processes are executed on the computer or another programmable device to produce computer-implemented processing, therefore, executing instructions on the computer or another programmable device provides processes for realizing functions specified in one process or multiple processes in the flowchart and/or one block or multiple blocks in the block diagram.

The above descriptions are merely embodiments of the present disclosure, and are not intended to limit the present disclosure. For those skilled in the art, the present disclosure can have various modifications and changes. Any modification, equivalent replacement, and improvement made within the principle of the present disclosure should be included in the scope of the present disclosure.

What is claimed is:

1. A map processing method comprising:
determining, in a map coordinate system, a first coordinate position corresponding to a position of a movable device;
determining, in the map coordinate system, a second coordinate position corresponding to pixel feature information of a map data source; and
determining an accessible state of a target coordinate position in a map according to the first coordinate position and the second coordinate position, the accessible state of the target coordinate position indicating that the target coordinate position is not occupied by obstacles.

2. The map processing method of claim 1, wherein:
the second coordinate position is not in the map, and the target coordinate position is between the first coordinate position and the second coordinate position; and
determining the accessible state of the target coordinate position according to the first coordinate position and the second coordinate position includes changing a state of the target coordinate position from a marked unknown state to the accessible state.

3. The map processing method of claim 1, wherein:
the second coordinate position is in the map, and the target coordinate position is between the first coordinate position and the second coordinate position; and
determining the accessible state of the target coordinate position according to the first coordinate position and the second coordinate position includes:
changing a state of the target coordinate position from a marked unknown state to the accessible state.

4. The map processing method of claim 3, wherein the target coordinate position is collinear with the first coordinate position and the second coordinate position.

5. The map processing method of claim 1, further comprising, after determining the second coordinate position:
determining an inaccessible state of another target coordinate position in the map according to the second coordinate position, the inaccessible state of the another target coordinate position indicating that the another target coordinate position is occupied by an obstacle.

6. The map processing method of claim 5, wherein:
the second coordinate position is in the map and the another target coordinate position is the second coordinate position; and
determining the inaccessible state of the another target coordinate position according to the second coordinate position includes changing a state of the second coordinate position from a marked unknown state to the inaccessible state.

7. The map processing method of claim 1, wherein determining the second coordinate position includes:
determining, in a coordinate system used by the map data source, an intermediate coordinate position corresponding to the pixel feature information of the map data source; and
transforming the intermediate coordinate position in the coordinate system used by the map data source to the second coordinate position in the map coordinate system according to a correspondence relationship between the coordinate system used by the map data source and the map coordinate system.

8. The map processing method of claim 7, wherein:
the coordinate system used by the map data source is a first coordinate system;
the pixel feature information includes a specified pixel feature of a pixel of the map data source and a source coordinate position of the pixel in a second coordinate system used by the map data source, the second coordinate system being different from the first coordinate system; and
determining the intermediate coordinate position in the first coordinate system includes:
determining a first coordinate-axis value of the intermediate coordinate position in the first coordinate system according to the specified pixel feature of the pixel; and
determining a second coordinate-axis value and a third coordinate-axis value of the intermediate coordinate position in the first coordinate system according to the source coordinate position of the pixel in the second coordinate system and the first coordinate-axis value.

9. The map processing method of claim 8, wherein:
the map data source is a parallax map, and the specified pixel feature is a parallax value and
determining the first coordinate-axis value of the intermediate coordinate position in the first coordinate system according to the specified pixel feature of the pixel includes:
converting the parallax value of the pixel in the map data source into a depth value; and
determining the depth value as the first coordinate-axis value of the intermediate coordinate position in the first coordinate system.

10. The map processing method of claim 7, wherein transforming the intermediate coordinate position in the first coordinate system to the second coordinate position in the map coordinate system includes:
transforming the intermediate coordinate position in the first coordinate system to a device coordinate system according to a correspondence relationship between the first coordinate system and the device coordinate system; and
transforming the intermediate coordinate position in the device coordinate system to the second coordinate position in the map coordinate system according to a correspondence relationship between the device coordinate system and the map coordinate system.

11. An electronic device comprising:
a memory storing program codes; and
a processor configured to execute the program codes to:
determine, in a map coordinate system, a first coordinate position corresponding to a position of a movable device;
determine, in the map coordinate system, a second coordinate position corresponding to pixel feature information of a map data source; and
determine an accessible state of a target coordinate position in a map according to the first coordinate position and the second coordinate position, the accessible state of the target coordinate position indicating that the coordinate position is not occupied by obstacles.

12. The electronic device of claim 11, wherein:
the second coordinate position is not in the map, and the target coordinate position is between the first coordinate position and the second coordinate position; and
the processor is configured to execute the program codes to:
change a state of the target coordinate position from a marked unknown state to the accessible state.

13. The electronic device of claim 11, wherein:
the second coordinate position is in the map, and the target coordinate position is between the first coordinate position and the second coordinate position; and
the processor is configured to execute the program codes to:
change a state of the target coordinate position from a marked unknown state to the accessible state.

14. The electronic device of claim 13, wherein the target coordinate position is collinear with the first coordinate position and the second coordinate position.

15. The electronic device of claim 11, wherein after determining the second coordinate position, the processor is configured to execute the program codes to:
determine an inaccessible state of another target coordinate position in the map according to the second coordinate position, the inaccessible state of the another target coordinate position indicating that the another target coordinate position is occupied by an obstacle.

16. The electronic device of claim 15, wherein:
the second coordinate position is in the map and the another target coordinate position is the second coordinate position; and
the processor is configured to execute the program codes to:
change a state of the second coordinate position from a marked unknown state to the inaccessible state.

17. The electronic device of claim 11, wherein when determining the second coordinate position, the processor is configured to execute the program codes to:
determine, in a coordinate system used by the map data source, an intermediate coordinate position corresponding to the pixel feature information of the map data source; and
transform the intermediate coordinate position in the coordinate system used by the map data source to the second coordinate position in the map coordinate system according to a correspondence relationship between the coordinate system used by the map data source and the map coordinate system.

18. The electronic device of claim 17, wherein:
the coordinate system used by the map data source is a first coordinate system;
the pixel feature information includes a specified pixel feature of a pixel of the map data source and a source coordinate position of the pixel in a second coordinate system used by the map data source, the second coordinate system being different from the first coordinate system; and
when determining the intermediate coordinate position in the first coordinate system, the processor is configured to execute the program codes to:
determine a first coordinate-axis value of the intermediate coordinate position in the first coordinate system according to the specified pixel feature of the pixel; and
determine a second coordinate-axis value and a third coordinate-axis value of the intermediate coordinate position in the first coordinate system according to the source coordinate position of the pixel in the second coordinate system and the first coordinate-axis value.

19. The electronic device of claim 18, wherein:
the map data source is a parallax map, and the specified pixel feature is a parallax value; and
when determining the first coordinate-axis value of the intermediate coordinate position in the first coordinate system according to the specified pixel feature of the pixel, the processor is configured to execute the program codes to:
convert the parallax value of the pixel in the map data source into a depth value; and
determine the depth value as the first coordinate-axis value of the intermediate coordinate position in the first coordinate system.

20. The electronic device of claim 17, wherein when transforming the intermediate coordinate position in the first coordinate system to the second coordinate position in the map coordinate system, the processor is configured to execute the program codes to:
transform the intermediate coordinate position in the first coordinate system to a device coordinate system according to a correspondence relationship between the first coordinate system and the device coordinate system; and
transform the intermediate coordinate position in the device coordinate system to the second coordinate position in the map coordinate system according to a correspondence relationship between the device coordinate system and the map coordinate system.
